(19) United States
(12) Patent Application Publication
(10) Pub. No.: US 2025/0377203 A1
(43) Pub. Date: Dec. 11, 2025

(54) INTELLIGENT INSPECTION DEVICE AND ITS OPERATING METHOD

(71) Applicants: INVENTEC (PUDONG) TECHNOLOGY CORPORATION, Shanghai (CN); INVENTEC CORPORATION, Taipei City (TW)

(72) Inventor: Ya-Wen HUNG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/943,227

(22) Filed: Nov. 11, 2024

(30) Foreign Application Priority Data
Jun. 5, 2024 (CN) 202410727513.6

(51) Int. Cl. G01C 21/20; G01N 21/88; G06V 30/14; G06V 30/19

(52) U.S. Cl. CPC G01C 21/206; G01N 21/8851; G06V 30/1444; G06V 30/19173; G01N 2021/8887; G06V 2201/06

(57) ABSTRACT

The present disclosure proposes an intelligent inspection device and its operating method. The intelligent inspection device includes a signal positioning module, an inertial positioning module, and a computing element. The operating method includes: obtaining a field signal by the signal positioning module from a signal collection point, collecting inertial positioning data by the inertial positioning module, obtaining a device location of the intelligent inspection device from the field signal, a collection point location of the signal collection point and a signal source location of the signal source from a database, and calculating a relative position of the intelligent inspection device with respect to the signal source, and calculating positioning information of the intelligent inspection device according to the relative position and the inertial positioning information, with the positioning information including a three-dimensional coordinate and an orientation angle.

### CROSS-REFERENCE TO RELATED APPLICATIONS

This non-provisional application claims priority under 35 U.S.C. § 119 (a) on Patent Application No(s). 202410727513.6 filed in China on Jun. 5, 2024, the entire contents of which are hereby incorporated by reference.

### BACKGROUND

### 1. Technical Field

The present disclosure relates to inspections and Artificial Intelligence (AI), particularly to an intelligent inspection device and its operating method.

### 2. Related Art

Inspection operations are an important part of the normal functioning of a factory. Various equipment and machines in the factory require inspection personnel to regularly check their status and report back to ensure that each piece of equipment and machine operates at its optimal production efficiency.

However, the existing inspection mechanisms have issues with human error. Due to new employees being unfamiliar with the inspection process, inspections are often not conducted thoroughly. While inspection personnel may be aware of their current tasks, they often cannot find the shortest route to the task location in a complex work environment. Additionally, considering that everyone's sense of direction differs, even when a map is provided, it cannot guarantee that inspection personnel will successfully reach the destination according to the map in a complicated work environment. Incomplete inspections may lead to the factory being unable to operate normally.

### SUMMARY

In light of the above descriptions, the present disclosure proposes an intelligent inspection device and its operating method to address the aforementioned issues.

According to one or more embodiment of the present disclosure, an intelligent inspection device operating method is applicable to an intelligent inspection device including a signal positioning module, an inertial positioning module, and a computing element. The method includes the following steps: obtaining, by the signal positioning module, a field signal through establishing a communication to a signal collection point, wherein the signal collection point is configured to collect the field signal emitted by a signal source; collecting, by the inertial positioning module, inertial positioning information; obtaining, by the computing element, a device location of the intelligent inspection device from the field signal, a collection point location of the signal collection point and a signal source location of the signal source from a database; and calculating a relative position of the intelligent inspection device with respect to the signal source; and calculating, by the computing element, positioning information of the intelligent inspection device according to the relative position and the inertial positioning information, wherein the positioning information includes a three-dimensional coordinate and an orientation angle.

According to one or more embodiment of the present disclosure, an intelligent inspection device includes a signal positioning module, an inertial positioning module and a computing element. The signal positioning module is configured to establish a communication to a signal collection point to obtain a field signal. The signal collection point is configured to collect the field signal emitted by a signal source. The inertial positioning module is configured to collect inertial positioning information. The computing element is electrically connected to the signal positioning module and the inertial positioning module. The computing element is configured to obtain a device location of the intelligent inspection device from the field signal, obtain a collection point location of the signal collection point and a signal source location of the signal source from a database, calculate a relative position of the intelligent inspection device with respect to the signal source, and the computing element is further configured to calculate positioning information of the intelligent inspection device according to the relative position and the inertial positioning information. The positioning information includes a three-dimensional coordinate and an orientation angle.

In view of the above, an embodiment of the present disclosure proposes an intelligent inspection device and its operating method, which adopts a combination of signal positioning and inertial positioning to solve the positioning issue in existing intelligent inspections. The positioning engine may automatically adjust the positioning algorithm according to the context and device status, reducing dependency on hardware and improving user experience. Signal positioning uses features such as signal strength and time delay from existing wireless infrastructure, while inertial positioning uses built-in sensors such as accelerometers, gyroscopes, and magnetometers to track the user's location and movements. By combining these two positioning methods, the present disclosure provides accurate indoor positioning.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the intelligent inspection device according to the first

embodiment of the present disclosure;

FIG. 2 is a flowchart of the intelligent inspection device operating method according to the first embodiment of the present disclosure;

FIG. 3 is a flowchart of the filtering operation according to an embodiment of the present disclosure;

FIG. 4 is a flowchart of the intelligent inspection device operating method according to the second embodiment of the present disclosure;

FIG. 5 is an example schematic diagram of automatic path planning according to an embodiment of the present disclosure;

FIG. 6 is a block diagram of the intelligent inspection device according to the

second embodiment of the present disclosure;

FIG. 7 is a flowchart of the intelligent inspection device operating method according to the third embodiment of the present disclosure;

FIG. 8 is a block diagram of the intelligent inspection device according to the third embodiment of the present disclosure; and

FIG. 9 is a flowchart of the intelligent inspection device operating method according to the fourth embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

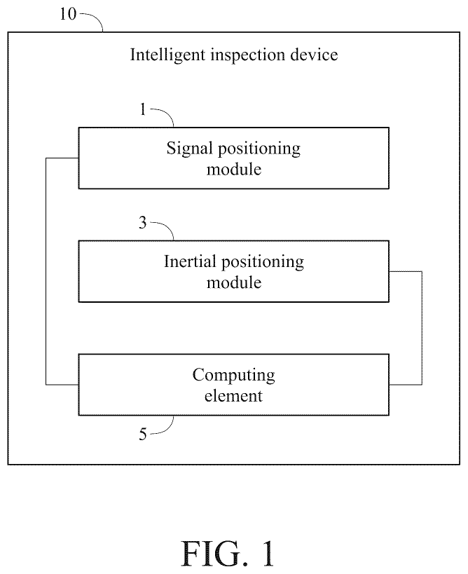

FIG. 1 is a block diagram of the intelligent inspection device according to the first embodiment of the present disclosure. As shown in FIG. 1, the intelligent inspection device 10 includes a signal positioning module 1, an inertial positioning module 3, and a computing element 5. The computing element 5 is electrically connected to the signal positioning module 1 and the inertial positioning module 3. In an embodiment, the intelligent inspection device 10 may adopt one of the following examples: a smartphone, a tablet, or a smart wearable device. The smart wearable device may be, for example, smart glasses (such as Microsoft HoloLens) or a smartwatch. The present disclosure does not limit the hardware type of the intelligent inspection device 10.

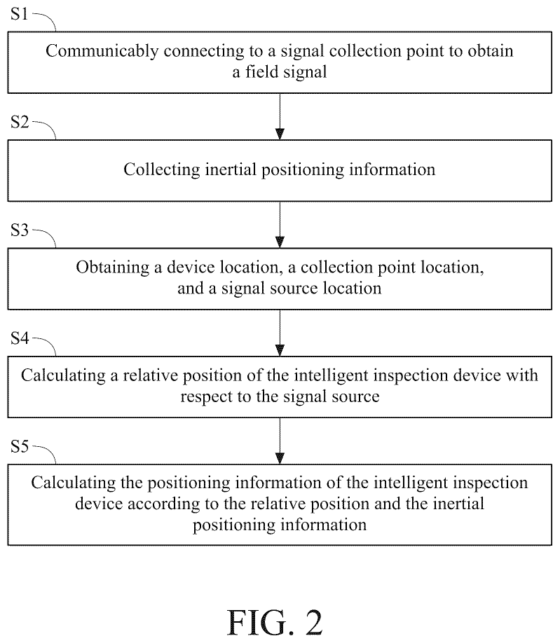

FIG. 2 is a flowchart of the intelligent inspection device operating method according to the first embodiment of the present disclosure. The method is applicable to the intelligent inspection device 10 as shown in FIG. 1. The following steps in FIG. 2 explain the technical details of each component of the inspection device as shown in FIG. 1.

In step S1, the signal positioning module 1 communicably connecting to a signal collection point to obtain a field signal. In other words, the signal positioning module 1 obtains a field signal through establishing a communication to a signal collection point. The signal collection point is configured to collect the field signal emitted by a signal source.

In the field applicable to the intelligent inspection device, such as a factory building, a plurality of signal sources and a plurality of signal collection points are disposed. The signal source is the origin of the transmitted signal. The signal emitted by the signal source is received by a sensor and is used for applications such as positioning and navigation. In an embodiment, the signal source may adopt at least one of the following examples: a Wi-Fi router, a Bluetooth device, GPS satellites, or 5G base stations/antennas. However, the present disclosure is not limited to these examples.

The signal collection point is a low-power device deployed in advance in the field and near the signal source, such as embedded sensors, Bluetooth beacons, or other types of IoT devices. The location information of the signal collection points is pre-registered in the inspection system. The signal collection point is configured to collect signals emitted by surrounding signal sources and to collect related signal data, such as at least one of signal strength, signal reception frequency, or signal reception time. These data may be used for applications such as positioning, navigation, and environmental monitoring.

The signal positioning module 1 is communicably connected to a signal collection point to obtain a field signal. The signal collection point is configured to collect the field signal emitted by a signal source. In an embodiment, the wireless communication standards supported by the signal positioning module 1 may adopt at least one of the following examples: 5^{th} Generation mobile networks (5G), Bluetooth, Wi-Fi, ZigBee, or Low Power Wide Area Networks (LPWAN, such as Lora, Sigfox, NB-IoT, etc.).

In step S2, the inertial positioning module 3 collects inertial positioning information. In an embodiment, the implementation of the inertial positioning module 3 may adopt at least one of the following examples: a gyroscope, a gravimeter, an accelerometer, a displacement meter, a magnetometer, or any sensor with distance and direction measurement capabilities. The inertial positioning information includes at least one of an acceleration value, an angle, or a displacement value.

In step S3, the computing element 5 obtains a device location of the intelligent inspection device 10 from the field signal, and obtains a collection point location of the signal collection point and a signal source location of the signal source from a database. When the field signal is a GPS signal, the device location may be in the form of latitude and longitude coordinates. The database refers to the backend server that the intelligent inspection device 10 may connect to, which records the locations of all signal sources and signal collection points deployed in advance in the field.

In an embodiment, the implementation of the computing element 5 may adopt at least one of the following examples: a personal computer, a network server, a microcontroller (MCU), an application processor (AP), a field programmable gate array (FPGA), an application-specific integrated circuit (ASIC), a system-on-a-chip (SoC), a deep learning accelerator, or any electronic device with similar functions. However, the present disclosure does not limit the hardware type of the computing element 5.

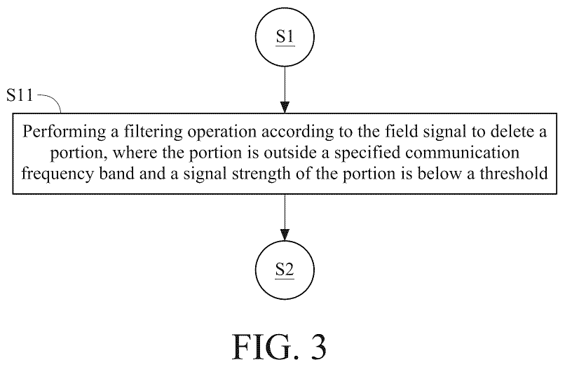

In an embodiment, after the signal positioning module 1 obtains the field signal, the computing element 5 also performs a filtering operation. FIG. 3 is a flowchart of the filtering operation according to an embodiment of the present disclosure. As shown in FIG. 3, step S11 is added between step S1 and step S2. In step S11, the computing element 5 performs a filtering operation according to the field signal to delete a portion, where the portion is outside a specified communication frequency band and a signal strength of the portion is below a threshold.

In step S4, the computing element 5 calculates a relative position of the intelligent inspection device 10 with respect to the signal source. In step S5, the computing element 5 calculates the positioning information of the intelligent inspection device 10 according to the relative position and the inertial positioning information. The positioning information includes a three-dimensional coordinate and an orientation angle. The orientation angle, for example, indicates the direction in which the face of the inspection personnel carrying the intelligent inspection device 10 is facing.

Overall, the intelligent inspection device operating method of the first embodiment of the present disclosure achieves hybrid positioning, and use the signal positioning technology to solve the issue that the inertial positioning requires a designated starting point. After the signal positioning module 1 collects the signal, the relative position of the intelligent inspection device 10 in the field may be estimated according to the device's connection status (including signal strength and signal transmission direction). The distance and direction sensor values provided by the inertial positioning module 3 are then integrated, allowing the positioning engine to perform filtering and triangulation calculations. The signal collection is done manually, and the signal features are imported into the computing element 5 running the AI algorithm system, which then automatically outputs the positioning information of the intelligent inspection device 10.

In other words, by comparing the device location, the collection point location, and the signal source location, the electromagnetic wave strength variation of the device and the relative distance to the signal collection point may be calculated. By further comparing the inertial positioning information obtained from the inertial positioning module, the relative distance calculation relationship between signal positioning and inertial positioning may be obtained. By comparing the spatial position of the real environment, hybrid positioning may be achieved.

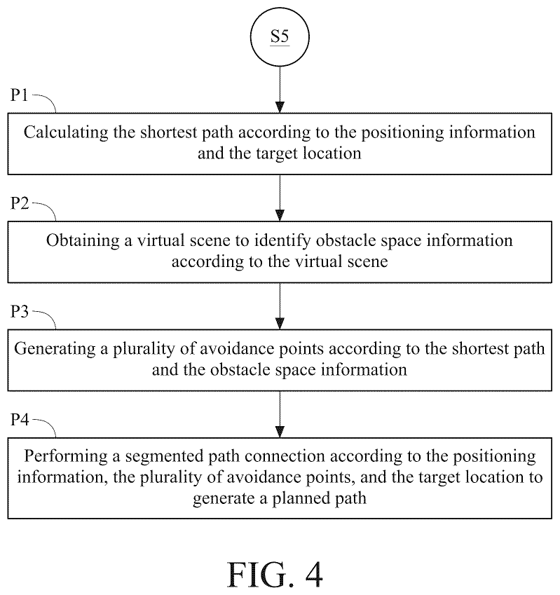

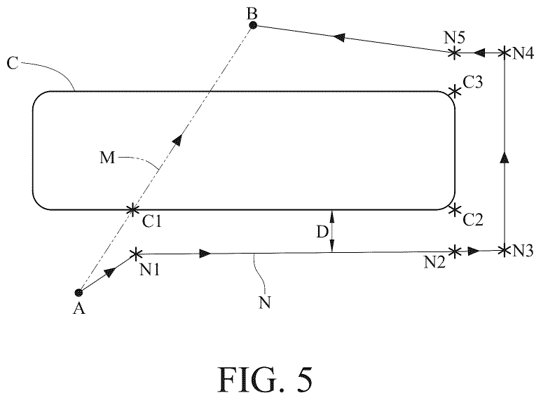

FIG. 4 is a flowchart of the intelligent inspection device operating method according to the second embodiment of the present disclosure. Compared to the first embodiment, the second embodiment further includes steps P1 to P4 after step S5. The second embodiment is used to achieve automatic path planning guidance in intelligent inspections. FIG. 5 is an example schematic diagram of automatic path planning according to an embodiment of the present disclosure.

In step P1, the computing element 5 calculates the shortest path according to the positioning information and the target location. In step P2, the computing element 5 obtains a virtual scene from the database to identify obstacle space information located between the positioning information and the target location according to the virtual scene. In step P3, the computing element 5 generates a plurality of avoidance points according to the shortest path and the obstacle space information. In step P4, the computing element 5 performs segmented path connection according to the positioning information, the plurality of avoidance points, and the target location to generate a planned path.

As shown in FIG. 5, the shortest path M is theoretically the straight-line connection between the current location A (positioning information obtained in step S5) and the target location B (manually set by inspection personnel or automatically assigned by the inspection system). However, obstacles C (obstacle space information obtained in step P2) may be encountered along the way. At this point, it is necessary to mark the interference point C1 on the shortest path M at the obstacle C, and find interference points C2 and C3 according to the area occupied by the obstacle C. Before generating the planned path N, it is also necessary to set an avoidance distance D between the path and the obstacle C. Based on the path interference points C1, C2, and C3, the plurality of avoidance points N1, N2, N3, N4, and N5 are automatically generated, and then the current location A is reconnected to the target location B, completing the new planned path N.

In an embodiment, the computing element 5 performs the A* pathfinding algorithm to generate the planned path N. In an embodiment, the virtual scene is constructed using the virtual environment development engine, Unity.

Overall, in the second embodiment, the inspection system constructs a virtual scene according to the real environment during development. Then, based on the hybrid positioning achieved in the first embodiment, the positioning information of the intelligent inspection device 10 is obtained as the current location. The computing element 5 then calculates the direction and the shortest path according to the coordinate of the target location B. The shortest path adopts the shortest straight-line distance, avoiding obstacles C, and connects point-to-point. The plurality of avoidance points N1-N5 are set to bypass the obstacle C. By calculating the avoidance points N1-N5 and using segmented path connections, the planned path N may be automatically generated.

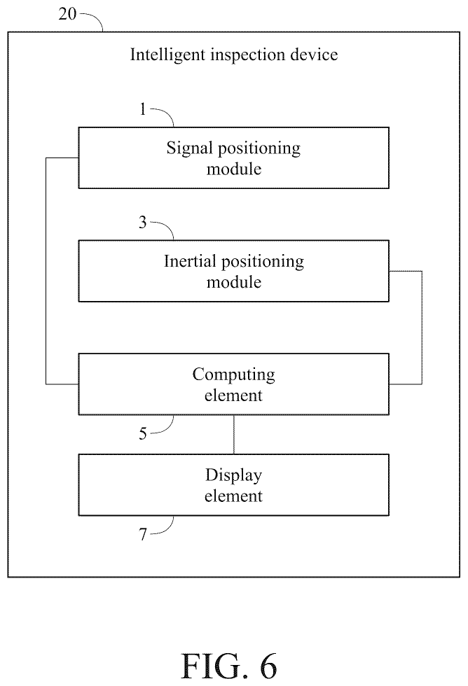

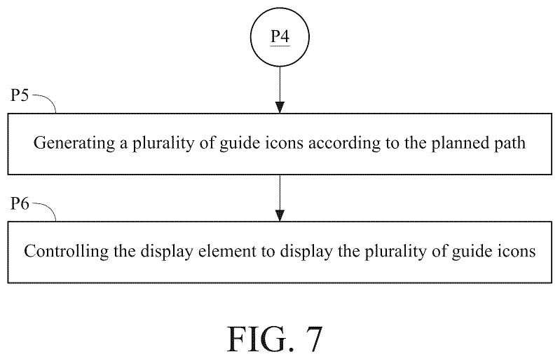

FIG. 6 is a block diagram of the intelligent inspection device according to the second embodiment of the present disclosure. Compared to the first embodiment, the intelligent inspection device 20 of the second embodiment further includes a display element 7, and the display element 7 is electrically connected to the computing element 5. FIG. 7 is a flowchart of the intelligent inspection device operating method according to the third embodiment of the present disclosure. Compared to the second embodiment, the intelligent inspection device operating method of the third embodiment further includes steps P5 and P6, and the method is applicable to the intelligent inspection device 20 shown in FIG. 6.

In step P5, the computing element 5 generates a plurality of guide icons according to the planned path N. In step P6, the computing element 5 controls the display element 7 to display the plurality of guide icons. Specifically, after the planned path N is generated, virtual icons (such as arrow indicators) may be overlaid onto the path through augmented reality (AR) technology for the inspection personnel to identify.

Overall, the intelligent inspection device operating methods proposed in the second and third embodiments of the present disclosure achieve automatic path planning and automatic route generation. By using artificial intelligence algorithms, the optimal route from the current location A to the target location B is generated. Additionally, by integrating the automatically planned path with AR technology's virtual icon elements and data information into the visual scene of the real world, the inspection personnel may see the virtual navigation route and arrows in the real world, guiding them along the predetermined route.

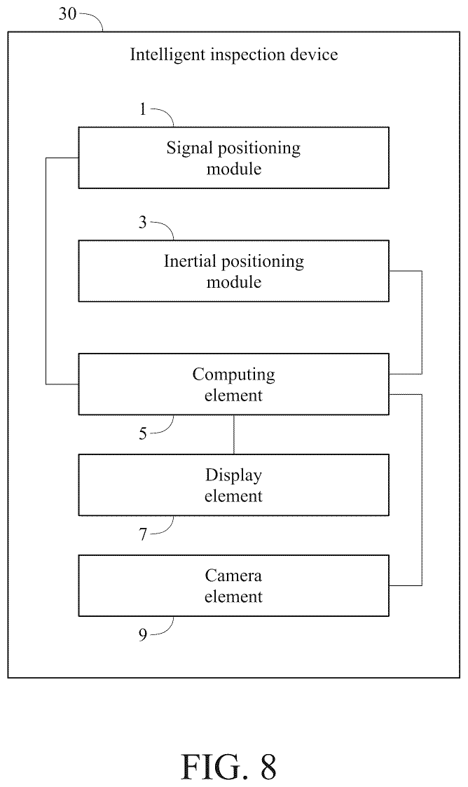

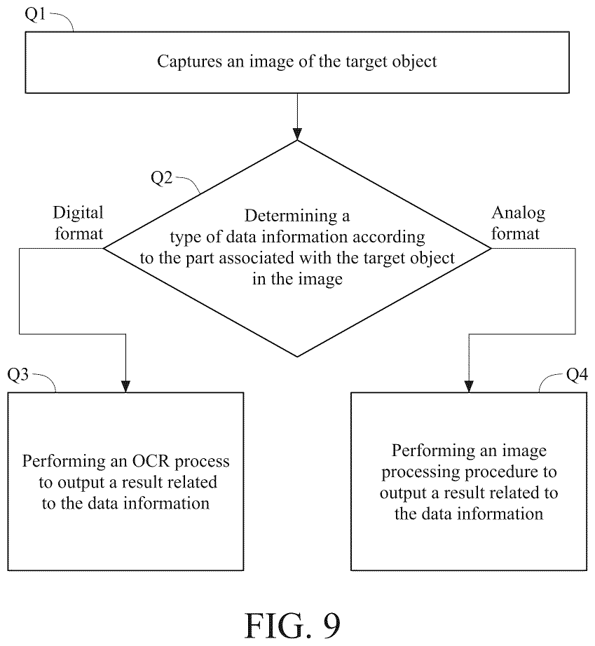

FIG. 8 is a block diagram of the intelligent inspection device according to the third embodiment of the present disclosure. Compared to the second embodiment, the intelligent inspection device 30 of the third embodiment further includes a camera element 9. The camera element 9 is electrically connected to the computing element 5. The camera element 9 is configured to capture an image of the target object. FIG. 9 is a flowchart of the intelligent inspection device operating method according to the fourth embodiment of the present disclosure. This embodiment is used to achieve automatic judgment of gauge data and is applicable to the application scenario where the inspection personnel, after arriving at the target location B, use the intelligent inspection device 30 to take measurements of gauge readings.

In step Q1, the camera element 9 captures an image of the target object. In this embodiment, the target object generally refers to a digital gauge or an analog gauge. A digital gauge displays data information in numeric form, while an analog gauge displays data information through a pointer and scale. In step Q2, the computing element 5 determines a type of data information according to the part associated with the target object in the image. The type includes digital format and analog format. In step Q3, when the type is digital, the computing element 5 performs an Optical Character Recognition (OCR) process to output a result related to the data information. In step Q4, when the type is analog, the computing element 5 performs an image processing procedure to output a result related to the data information. In an embodiment, the image processing procedure includes the following steps: identifying the maximum and minimum values of the scale, determining the position of the pointer, calculating the start and end points of the scale, locating the center of the scale, and converting the pointer result.

In an embodiment, before step Q1, the following process for configuring the intelligent inspection system is included: collecting various gauge patterns in advance, with the image collection covering multiple shooting angles and fluctuating light environments, including fluorescent light environments without fixed illumination intensity and natural light environments, all considered as fluctuating light environments with complex backgrounds. The gauge types are classified by object matching; early image processing enhances contour and contrast, separates and recognizes target objects, and performs image segmentation. Later, through artificial intelligence learning and data interpretation, repeated learning achieves usable recognition rates. The classification method for gauges includes scanning the object's shape and categorizing the gauge types, which may be divided into digital gauges and analog gauges. For example, a digital gauge may be a seven-segment display, while an analog gauge may be a pointer-type gauge.

Overall, the intelligent inspection device 30 proposed in the third embodiment of the present disclosure, as well as the intelligent inspection device operation method proposed in the fourth embodiment, achieve efficient gauge reading, barcode reading, and defect detection through the combination of artificial intelligence automatic interpretation and image processing technology. Through deep learning and computer vision algorithms, it may accurately recognize gauge information such as numbers and text, enabling automated data collection. Additionally, artificial intelligence technology may quickly identify and decode barcodes, improving material tracking and inventory management efficiency. Most importantly, artificial intelligence may detect defects on product surfaces, such as cracks, color inconsistencies, and wear, achieving automated quality control and reducing defect rates. The combination of these technologies effectively enhances the level of automation and production quality on the production line, creating greater efficiency and competitiveness for enterprises.

In view of the above, an embodiment of the present disclosure proposes an intelligent inspection device and its operating method, which adopts a combination of signal positioning and inertial positioning to solve the positioning issue in existing intelligent inspections. The positioning engine may automatically adjust the positioning algorithm according to the context and device status, reducing dependency on hardware and improving user experience. Signal positioning uses features such as signal strength and time delay from existing wireless infrastructure, while inertial positioning uses built-in sensors such as accelerometers, gyroscopes, and magnetometers to track the user's location and movements. By combining these two positioning methods, the present disclosure provides accurate indoor positioning.

In an embodiment of the present disclosure, the intelligent inspection device and its operating method may be applied to systems composed of 5G private networks and 5G small base stations.

What is claimed is:

1. An intelligent inspection device operating method applicable to an intelligent inspection device comprising a signal positioning module, an inertial positioning module, and a computing element, wherein the method comprises:
obtaining, by the signal positioning module, a field signal through establishing a communication to a signal collection point, wherein the signal collection point is configured to collect the field signal emitted by a signal source;
collecting, by the inertial positioning module, inertial positioning information;
obtaining, by the computing element, a device location of the intelligent inspection device from the field signal, a collection point location of the signal collection point and a signal source location of the signal source from a database, and calculating a relative position of the intelligent inspection device with respect to the signal source; and
calculating, by the computing element, positioning information of the intelligent inspection device according to the relative position and the inertial positioning information, wherein the positioning information comprises a three-dimensional coordinate and an orientation angle.

2. The intelligent inspection device operating method of claim 1, wherein the field signal comprises at least one of a signal strength, a signal reception frequency and a signal reception time.

3. The intelligent inspection device operating method of claim 1, wherein the inertial positioning comprises at least one of an acceleration value, an angle and a displacement value.

4. The intelligent inspection device operating method of claim 1, further comprising:
performing, by the computing element, a filtering operation on the field signal to delete a portion of the field signal, wherein the portion is outside a specified communication frequency band and a signal strength of the portion is below a threshold.

5. The intelligent inspection device operating method of claim 1, further comprising:
calculating, by the computing element, a shortest path according to the positioning information and a target location;
obtaining, by the computing element, a virtual scene from the database to identify obstacle space information located between the positioning information and the target location according to the virtual scene;
generating, by the computing element, a plurality of avoidance points according to the shortest path and the obstacle space information; and
performing, by the computing element, a segmented path connection according to the positioning information, the plurality of avoidance points, and the target location to generate a planned path.

6. The intelligent inspection device operating method of claim 5, wherein the computing element performs an A* pathfinding algorithm to generate the planned path.

7. The intelligent inspection device operating method of claim 5, wherein the intelligent inspection device further comprises a display element, and the method further comprises:
generating, by the computing element, a plurality of guide icons according to the planned path; and
controlling, by the computing element, the display element to display the plurality of guide icons.

8. The intelligent inspection device operating method of claim 1, wherein the intelligent inspection device further comprises a camera element, and the method further comprises:
capturing, by the camera element, an image of a target object, wherein the target object is configured to display data information;
determining, by the computing element, a type of the data information according to a portion of the image associated with the target object;
performing, by the computing element, an optical character recognition process to output a result associated with the data information when the type is digital; and
performing, by the computing element, an image processing procedure to output the result associated with the data information when the type is analog.

9. An intelligent inspection device comprising:
a signal positioning module configured to establish a communication to a signal collection point to obtain a field signal, wherein the signal collection point is configured to collect the field signal emitted by a signal source;
an inertial positioning module configured to collect inertial positioning information; and
a computing element electrically connected to the signal positioning module and the inertial positioning module, wherein the computing element is configured to obtain a device location of the intelligent inspection device from the field signal, obtain a collection point location of the signal collection point and a signal source location of the signal source from a database, calculate a relative position of the intelligent inspection device with respect to the signal source, and the computing element is further configured to calculate positioning information of the intelligent inspection device according to the relative position and the inertial positioning information, wherein the positioning information comprises a three-dimensional coordinate and an orientation angle.

10. The intelligent inspection device of claim 9, wherein the field signal comprises at least one of a signal strength, a signal reception frequency and a signal reception time.
